(19) United States
(12) Patent Application Publication
(10) Pub. No.: US 2023/0005014 A1
(43) Pub. Date: Jan. 5, 2023

(54) METHODS AND APPARATUS TO REDUCE FALSE CREDITING FROM DELAYED REFERENCE SITES

(71) Applicant: The Nielsen Company (US), LLC, New York, NY (US)

(72) Inventor: Sandeep Tapse, Odessa, FL (US)

(21) Appl. No.: 17/364,356

(22) Filed: Jun. 30, 2021

(51) Int. Cl. G06Q 30/02; H04L 29/06

(52) U.S. Cl. CPC G06Q 30/0248; H04L 65/60

(57) ABSTRACT

Methods, apparatus, systems and articles of manufacture are disclosed to reduce false crediting from delayed reference sites. An apparatus includes memory, computer readable instructions, and a processor to execute instructions to generate a list of first media resources mapped to durations of time, the first media resources having corresponding monitored timestamps, the first media resources to represent monitored media exposure, generate a mapping of the durations of time to percentages of total media exposure, the total media exposure corresponds to a sum of the durations of time, determine, based on the mapping, a group of the first media resources that correspond to a threshold percentage of the total media exposure, and determine whether to execute a media crediting process based on whether the group of the first media resources have first timestamps corresponding second timestamps of second media resources stored in memory, the second media resources represent reference media sources.

### FIELD OF THE DISCLOSURE

This disclosure relates generally to crediting, and, more particularly, to methods and apparatus to reduce false crediting from delayed reference sites.

### BACKGROUND

A media monitoring entity can generate media signatures, such as audio signatures, video signatures, etc., from a media signal. Media signatures are a condensed reference that can be used to subsequently identify the media. In some examples, a reference site can monitor a media source feed (e.g., a television feed, etc.) to generate reference signatures representative of media presented via that media source feed. Such reference signatures can be compared to the media signatures generated by media monitors to credit viewership of the media.

### BRIEF DESCRIPTION OF THE DRAWINGS

FIG. 1 is a block diagram of an example system to credit media consumption.

FIG. 2 is a block diagram of an example central facility of FIG. 1 to execute a crediting process to credit media consumption.

FIG. 3 is an example table of monitored media data and corresponding durations of exposure maintained by the example central facility of FIGS. 1 and/or 2.

FIG. 4 is an example mapping between reference timestamps of reference media resources and monitored timestamps of monitored media resources maintained by at the example central facility of FIGS. 1 and/or 2.

FIG. 5 is a flowchart representative of machine readable instructions which may be executed to implement the example central facility of FIGS. 1 and/or 2 to determine whether to execute a crediting process.

FIG. 6 is a flowchart representative of machine readable instructions which may be executed to implement the example central facility of FIGS. 1 and/or 2 to determine whether to execute a crediting process based on timestamps of media resources.

FIG. 7 is a flowchart representative of machine readable instructions which may be executed to implement the example central facility of FIGS. 1 and/or 2 to determine whether to execute a crediting process based on source identifiers of media resources.

FIG. 8 is a block diagram of an example processing platform structured to execute the instructions of FIGS. 5, 6 and/or 7 to implement the example central facility of FIGS. 1 and/or 2.

FIG. 9 is a block diagram of an example software distribution platform (e.g., one or more servers) to distribute software (e.g., software corresponding to the example machine readable instructions of FIGS. 5-7) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

The figures are not to scale. In general, the same reference numbers will be used throughout the drawing(s) and accompanying written description to refer to the same or like parts.

Unless specifically stated otherwise, descriptors such as “first,” “second,” “third,” etc. are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

### DETAILED DESCRIPTION

As used herein, the term “media” and/or “media asset” includes any type of content and/or advertisement delivered via any type of distribution medium. Thus, a media asset includes television programming or advertisements, radio programming or advertisements, movies, web sites, streaming media, etc. As used herein, the terms “credit” and/or “crediting” is defined as assigning exposure measurements (e.g., numbers of audience members that have been exposed to the media for a predefined period of time) and/or consumption measurements to a media source, such as a media service, an advertisement service, a particular media asset (e.g., a program, show, commercial, etc.), etc.

In some examples, watermarking is used to identify media (e.g., a media asset) such as television broadcasts, radio broadcasts, advertisements (television and/or radio), downloaded media, streaming media, prepackaged media, etc., for crediting. Existing watermarking techniques identify media assets by embedding one or more codes (e.g., one or more watermarks), such as media identifying information and/or an identifier that may be mapped to media identifying information, into an audio and/or video component of the media asset. In some examples, the watermark is embedded in the audio and/or video component so that the watermark is hidden.

As used herein, the terms “code” or “watermark” are used interchangeably and are defined to mean any identification information (e.g., an identifier) that may be inserted or embedded in the audio and/or video of media assets (e.g., a program or advertisement) for the purpose of identifying the media assets and/or for another purpose such as tuning (e.g., a packet identifying header). A watermark identifier (ID) may be any type of numerical value assigned by media entity, a media source, etc.

In some examples, to identify watermarked media, the watermark(s) are extracted and used to access a table of reference watermarks that are mapped to media identifying information. In some examples, media monitoring companies provide watermarks and watermarking devices to media providers with which to encode their media source feeds. In some examples, if a media provider provides multiple media source feeds (e.g., ESPN and ESPN 2, etc.), a media provider can provide a different watermark for each media source feed. In some examples, a media provider could encode a media source feed with an incorrect watermark (e.g., a watermark meant for ESPN could accidentally be encoded on ESPN2, etc.). In such an example, crediting using only watermarking could result in the wrong media source feed being credited.

In some examples, signature matching is used to identify media assets. Unlike media monitoring techniques based on codes and/or watermarks included with and/or embedded in the monitored media, fingerprint or signature-based media monitoring techniques generally use one or more inherent characteristics of a monitored media asset during a monitoring time interval to generate a substantially unique proxy for the media asset. Such a proxy is referred to as a signature or fingerprint, and can take any form (e.g., a series of digital values, a waveform, etc.) representative of any aspect(s) of the media signal(s) (e.g., the audio and/or video signals forming the media presentation being monitored). A signature may be a series of signatures collected in series over a time interval. Accordingly, the terms “fingerprint” and “signature” are used interchangeably herein and are defined herein to mean a proxy for identifying a media asset that is generated from one or more inherent characteristics of the media.

Signature-based media monitoring generally involves determining (e.g., generating and/or collecting) signature(s) representative of a media signal (e.g., an audio signal and/or a video signal) output by a monitored media device and comparing the monitored signature(s) to one or more references signatures corresponding to known (e.g., reference) media source feeds. Various comparison criteria, such as a cross-correlation value, a Hamming distance, etc., can be evaluated to determine whether a monitored signature matches a particular reference signature. When a match between the monitored signature and a reference signature is found, the monitored media asset can be identified as corresponding to the particular reference media asset represented by the reference signature that matched with the monitored signature. Example systems for identifying media assets based on codes and/or signatures are long known and were first disclosed in Thomas, U.S. Pat. No. 5,481,294, which is hereby incorporated by reference in its entirety. As used herein, a signature, a fingerprint, a code, and/or a watermark that has been obtained, generated, processed, and/or more generally, monitored by a meter and/or any type of media monitoring device is referred to as a monitored media resource. As used herein, a reference signature, a reference fingerprint, a reference code, and/or a reference watermark that has been generated at a back office, at a media monitoring site (MMS), and/or at a facility that “knows” the media asset is referred to as a reference media resource.

In some examples, time triggers are used to enable matching between monitored media resources (e.g., monitored signatures, monitored watermarks, etc.) and reference media resources (e.g., reference signatures, reference watermarks, etc.). For example, meters that monitor media assets presented to panelists may be configured to send monitored media resources (e.g., monitored signatures, monitored watermarks, etc.) to a central facility at specific time periods. Also, in some examples, a reference site (e.g., associated with a media monitoring company) may be configured to send reference media resources corresponding to known media assets to the central facility at specific time periods to enable identification of the monitored media resources. Examples of such specific time periods include, but are not limited to, every thirtieth minute of the hour, every fifteenth minute of the hour, every 10 minute of the hour, etc.

In some examples, the time triggers enable live matching and/or live mapping between monitored media resources and reference media resources. Live matching includes matching monitored media resources (e.g., monitored signatures) to reference media resources (e.g., reference signatures) for identifying a media asset that is broadcasted/streamed in real time. Live mapping includes mapping reference media resources (e.g., reference watermarks) to known information (e.g., channel, title, time, etc.) as they are live streaming. In some examples, live matching and/or live mapping is accurate (e.g., the matching and/or mapping produces desirable results) when a reference site generates reference media resources at the time reference media assets are broadcasted by respective media sources. For example, a meter sends monitored media resources to a back office (e.g., the central facility) every 10 minutes corresponding to a live broadcasting of a particular media asset. In such an example, a reference site that monitors the media source broadcasting the same media asset, sends known reference media resources to the back office every 10 minutes for the back office to utilize when performing live matching and/or live mapping.

To generate reference media resources, reference sites obtain information from the media sources to be monitored. Such information includes program titles, intended time of airing, channel information, etc. In some examples, the reference sites utilize this information to determine when to collect and/or generate reference media resources, when to send reference media resources to the central facility, etc. In some examples, reference sites may be delayed in sending reference media resources to the central facility. For example, errors may occur at reference sites, such as network access to the central facility being down, a clock at the reference site being offset from a correct time, etc. In such examples, live matching and/or live mapping becomes less accurate due to the unavailability of and/or lack of reference media resources.

In some examples, a reference site can be used by the central facility for detecting watermarks. For example, the reference site may decode watermarks from media as the media undergoes live airing/streaming. Then, the reference site may map the decoded watermarks to a channel that the reference site knows the watermark came from and timestamp the watermark with extra information, such as a title, a distribution source ID, etc. The example reference site may load the central facility with the decoded reference watermarks, which can then be used in case a meter did not have enough information from a monitored watermark to actually identify who broadcasted and encoded the watermark in the channel. In some examples, a watermark may not contain enough information to identify the media source encoding the watermark in the media asset due to syndication. For example, syndication is the sale or licensing of media for broadcasting by a number of media sources. Therefore, some watermarks may not identify an original distributor (e.g., the media source that actually broadcasted the media) and instead, only include a source identifier (e.g., corresponding to a final distributor of the media). In such examples, the central facility can utilize the reference watermark to identify the original distributor. In examples where the reference site fails to map reference watermarks to media identifying data (e.g., the original distributor, etc.), the central facility may obtain a number of monitored watermarks that cannot be further identified for additional media identifying information.

Example methods, apparatus, and articles of manufacture disclosed herein determine when to execute a crediting process to credit media. Examples disclosed herein do not follow a time-based trigger to begin crediting monitored media resources. Instead, examples disclosed herein generate a list of monitored media resources and determine whether a threshold amount of reference media resources are available to use for crediting. In some examples disclosed herein, if the threshold amount of reference media resources are not available, examples disclosed herein do not process the monitored media resources but, instead, generate a report including a number of reference media resources that were missing at the time the monitored media resources were sent. In some examples, a number of monitored media resources and corresponding timestamps are used to determine whether reference media resources are available for those corresponding timestamps. For example, if the central facility cannot identify matching timestamps between the reference media resources and the monitored media resources for a threshold amount of the monitored media resources, examples disclosed herein do not execute the crediting process. As such, examples disclosed herein can increase the accuracy and quality of identifying media assets in monitored media resources by delaying execution of the crediting process until a threshold amount of reference data is available.

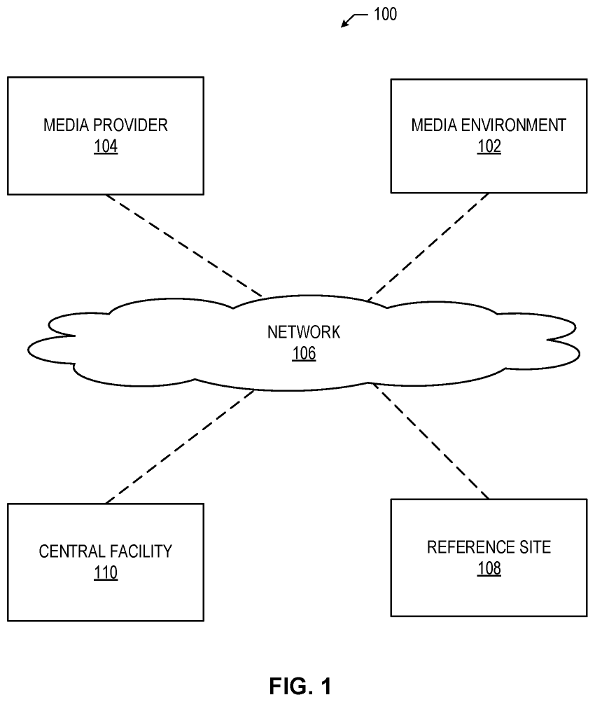

FIG. 1 is a block diagram of an example system 100 to credit media consumption. The example system 100 includes an example media environment 102, an example media provider 104, an example network 106, an example reference site 108, and an example central facility 110.

In FIG. 1, the example media environment 102 is a household (e.g., a room in a home of a panelist, such as the home of a “Nielsen family”) that has been statistically selected to develop media ratings data for a population/demographic of interest. The example media environment 102 includes media devices to present media to the panelist and media monitoring devices (also referred to as monitoring devices, media meters, device meters, meters, etc.) to collect the media presented to the panelist. In some examples, the media devices are consumer electronics. For example, one of the devices may be a personal computer such as a laptop computer, and thus, is capable of directly presenting media (e.g., via an integrated and/or connected display and speakers). Additionally and/or alternatively, any other type(s) and/or number(s) of device(s) may additionally or alternatively be used. For example, Internet-enabled mobile handsets (e.g., a smartphone, an iPod®, etc.), video game consoles (e.g., Xbox®, PlayStation 3, etc.), tablet computers (e.g., an iPad®, a Motorola™ Xoom™, etc.), digital media players (e.g., a Roku® media player, a Slingbox®, a Tivo®, etc.), smart televisions, desktop computers, laptop computers, servers, IoT devices, watches (e.g., smartwatches), fitness trackers, headsets, vehicle control units (e.g., an engine control unit, an electronic control unit, etc.), edge devices, etc. may additionally or alternatively be used. In some examples, the media monitoring devices are meters used to monitor exposure to media by collecting monitored media resources (e.g., monitored media signatures, monitored media watermarks, etc.) representative of the presented media. In examples disclosed herein, exposure of media corresponds to media consumption. The monitored media resources are transmitted by a media monitoring device to the example central facility 110 via the example network device 106. While the monitored media resources are transmitted by electronic transmission in FIG. 1, the monitored media resources may additionally or alternatively be transferred in any other manner, such as, for example, by physically mailing the meter, by physically mailing a memory of the meter, etc.

In FIG. 1, the example media provider 104 includes one or more servers providing Internet media (e.g., web pages, audio, video, images, etc.), broadcasted media, etc. The example media provider 104 of FIG. 1 may be implemented by any provider(s) of media such as a digital media broadcaster, a multicaster, a unicaster (e.g., a cable television service, a fiber-optic television service, an IPTV provider, etc.), an on-demand digital media provider (e.g., an Internet streaming video and/or audio service such as Netflix®, YouTube®, Hulu®, Pandora®, Last.fm®, etc.), a web page (e.g., an online store such as Amazon.com®), and/or any other provider and/or creator of media.

In FIG. 1, the example network 106 is a wide area network (WAN) such as the Internet. However, in some examples, local networks may additionally or alternatively be used. For example, multiple networks (e.g., a cellular network, an Ethernet network, etc.) may be utilized to implement the example network 106 of FIG. 1.

In FIG. 1, the example reference site 108 generates reference media resources (e.g., reference signatures and/or reference watermarks) for use in identifying media exposure data. In some examples, the reference site 108 is a Media Monitoring Site (MMS) located at a media market. An MMS may generate, collect, and/or process data from a variety of media providers and/or media sources within a physical range of the site. For example, an MMS located in Chicago, Ill. may generate reference signatures and/or decode and map reference watermarks by collecting network traffic occurring between a device at the media environment 102 and a broadcast station or Internet Service Provider (ISP) located in Chicago, Ill. In some examples, the reference site 108 may be implemented by the central facility 110. In other examples, the reference site 108 is an MMS located at the central facility 110. In some examples, the reference site 108 generates and/or decodes reference media resources based on one or more receivers (e.g., tuners) that are tuned (or timeshared) over all the monitored channels of interest. In some examples, the reference site 108 knows the channel to which a given receiver is tuned, so the reference site 108 can map the detected watermarks and/or generated signatures to the channel broadcasting and/or streaming the media. In some examples, the reference site 108 adds timestamps indicating when the watermarks were detected and/or when the signatures were generated. The example reference site 108 provides reference media resources to the central facility 110 via the example network 106.

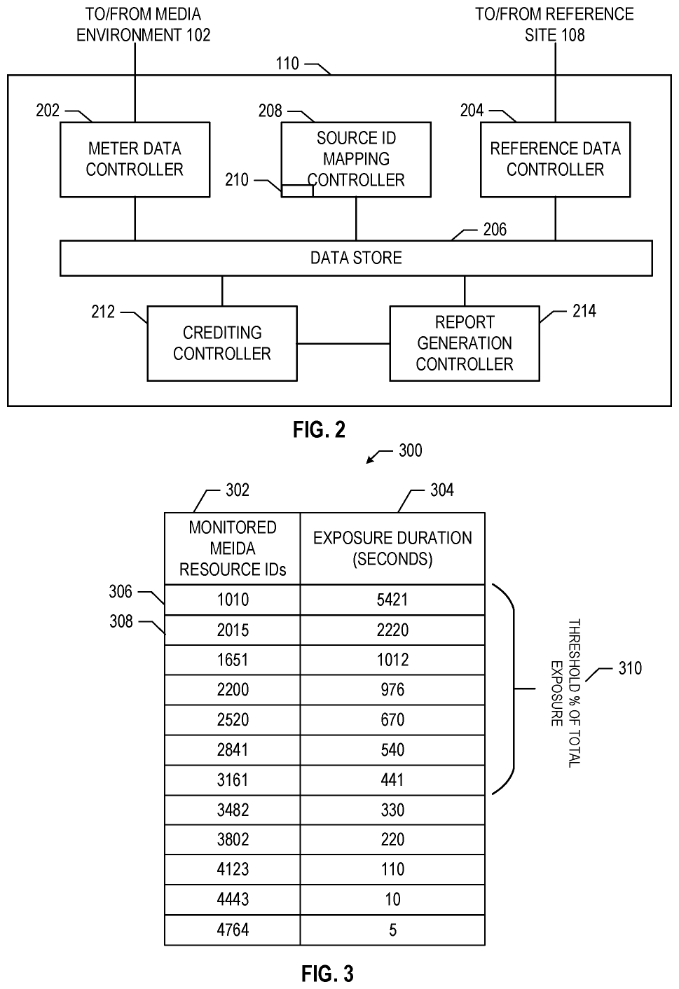

In FIG. 1, the example central facility 110 performs operations at the back-end of media monitoring. For example, the central facility 110 processes data (e.g., monitored media resources) from the meters to determine exposure data. In some examples, the central facility 110 obtains user identifying information, monitored media resources, and reference media resources to process and determine exposure data. In some examples, the central facility 110 performs live matching and/or live mapping. To avoid erroneously matching and/or mapping monitored media resources with unavailable reference media resources, the example central facility 110 determines whether a threshold amount of monitored media resources can be matched. In some examples, when the central facility 110 determines a threshold amount of monitored media resources cannot be matched and/or mapped, the central facility 110 does not perform and/or execute the crediting process until enough reference media resources are available. The example central facility 110 is described in further detail below in connection with FIG. 2.

FIG. 2 is a block diagram of the example central facility 110 of FIG. 1 to determine to execute a crediting process. In FIG. 2, the example central facility 110 includes an example meter data controller 202, an example reference data controller 204, an example data store 206, an example source identifier (ID) mapping controller 208, an example crediting controller 212, and an example report generation controller 214.

In FIG. 2, the example meter data controller 202 is implemented by a processor. The example meter data controller 202 obtains monitored media resources from the example media environment 102 via the network 106. In some examples, the meter data controller 202 obtains monitored media resources in intervals of time and/or at specific times of a day. The example meter data controller 202 is coupled to or otherwise communicates with an example data store 206 to store (e.g., cache) monitored media resources as they are obtained from the example media environment 102. In some examples, the meter data controller 202 stores monitored media resources with corresponding timestamps to use for subsequent processing. For example, a meter of the media environment 102 may provide monitored watermark identifiers (IDs) with a timestamp corresponding to the time of collection (e.g., a time of access by and/or presentation of and/or exposure to the media). As used herein, the timestamp stored with the monitored media resources and reference media resources is referred to herein as a collection timestamp. In some examples, the timestamp included in monitored media resources and reference media resources is referred to herein as an embedded timestamp. Embedded timestamps can be extracted from the monitored media resources to use during the crediting process and is indicative of a position in the monitored media asset that is represented by the ID included in the monitored media resource. The collection timestamps of monitored media resources can be used to determine a duration of exposure. As used herein, a duration of exposure corresponds to a period of time that a panelist member is and/or was exposed to the media corresponding to the monitored media resource. For example, if five monitored media resources having time stamps of 9:00, 9:01, 9:02, 9:03, and 9:04, were obtained by the meter and were associated with the same media source (e.g., channel A), the meter data controller 202 determines that the media source has a duration of exposure corresponding to four minutes. In some examples, the meter of the media environment 102 may provide the duration of exposure for each media source viewed in the period of time that the meter monitored the media devices. In such an example, the meter data controller 202 can determine a total duration of exposure based on each duration provided for the different media sources. For example, the meter data controller 202 obtains five monitored media resources corresponding to channel A and four minutes of exposure, obtains fifteen monitored media resources corresponding to a channel B and 15 minutes of exposure, and obtains 11 monitored media resources corresponding to a channel C and 11 minutes of exposure. The example meter data controller 202 determines that the total duration of exposure is 30 minutes based on the durations associated with the monitored media resources.

In some examples, the meter data controller 202 generates and/or compiles a list of monitored media resources and their corresponding durations. Additionally and/or alternatively, the example meter data controller 202 generates a table, an array, and/or any other data structure and/or more generally information describing the monitored media resources and their corresponding durations. In some examples, the meter data controller 202 stores such a list, table, array, etc., in the data store 206. The example list of information describing the monitored media resources is described in further detail below in connection with FIG. 3. The example meter data controller 202 generates a chart that maps the durations of the monitored media resources to percentages of total exposure. For example, the meter data controller 202 generates a Pareto chart with the list of monitored media resources and exposure durations. Additionally and/or alternatively, the example meter data controller 202 generates a graph, a diagram, a plot, and/or any type of statistical data structure describing the percentages of total exposure of the monitored media resources. A Pareto chart is a type of chart that contains both bars and a line graph, where individual values (e.g., monitored media resource values) are represented in descending order by bars, and a cumulative total (e.g., the total duration of exposure) is represented by the line. The example meter data controller 202 can utilize any graphing algorithms and/or any statistical algorithms to generate the chart that maps the durations of the monitored media resources to percentages of total exposure.

FIG. 3 depicts an example list 300 of monitored media resources identifiers and corresponding durations of exposure. The information included in the list 300 may be in any form, such as a table, an array, and/or any other data structure. The example meter data controller 202 stores the example list 300 in the data store 206 to be accessible by the example source ID mapping controller 208, the example reference data controller 204, the example crediting controller 212, and the example report generation controller 214. The example list 300 of FIG. 3 includes a first column of data 302 and a second column of data 304. The example first column of data 302 illustrates monitored media resource identifiers of the monitored media resources. The monitored media resource identifiers of the monitored media resources are numerical values representative of media sources. For example, a first row 306 includes monitored media resource ID 1010, which may be representative of channel A and a second row 308 includes monitored media resource ID 2015, which may be representative of channel B. In some examples, each monitored media resource ID has a corresponding source identifier. As used herein, a “source identifier” is an identifier distributed to a media provider and/or media source for identifying the media provider and/or media source. In some examples, the source identifier is different than the monitored media resource identifier. In some examples, the source identifier is the same as the monitored media resource identifier.

In FIG. 3, the example second column of data 304 illustrates exposure durations. The example exposure durations are illustrated in seconds, but can be any measurement of time (e.g., milliseconds, minutes, hours, days, etc.). The example meter data controller 202 populates the second column of data 304 based on the monitored media resource identifiers of the monitored media resources. For example, the meter data controller 202 extracts the exposure durations from the monitored media resources obtained from the media environment 102 and/or calculates the exposure durations from the collection timestamps. In FIG. 3, the example first row 306 illustrates that monitored media resource ID 1010 includes an exposure duration of 5421 seconds and the example second row 308 illustrates that monitored media resource ID 2015 includes an exposure duration of 2220 seconds.

The example list 300 of FIG. 3 illustrates a group 310 of monitored media resource IDs that correspond to a threshold percent of total exposure. In examples disclosed herein, the threshold percent corresponds to 95%. In some examples, the threshold percent may correspond to any other percentage of exposure. In some examples, the meter data controller 202 calculates the threshold percent based on summing the exposure durations to determine the total exposure duration of the monitored media resources, then determining a percentage of that total exposure that corresponds to the threshold. In some examples, the meter data controller 202 determines which monitored media resources make up the threshold percentage of total exposure based on the chart. Although the example list 300 illustrates monitored media resources sorted based on durations, the example list 300 may illustrate the monitored media resources in any type of way (e.g., based on the values of the monitored media resource ID, based on the time at which they were collected, etc.). As such, the example meter data controller 202 may determine the group 310 based on any combination of exposure durations.

Turning back to FIG. 2, the example meter data controller 202 maps monitored media resource identifiers to source identifiers. For example, the meter data controller 202 may process decoded watermarks. As such, the decoded watermarks may include identifiers (e.g., included in a header of the payload of the watermark, etc.) that can be mapped to source identifiers which are indicative of a media source. In some examples, the monitored media resource identifiers are source identifiers and are to be mapped to media identifying information corresponding to the source identifier. In some examples, the meter data controller 202 utilizes the source identifiers to search the data store 206 for similar source identifiers of reference media resources. In some examples, the reference media resources are decoded watermarks having source identifiers that are mapped to a number of media identifying information, such as original distribution identifiers, channel information, media asset titles, etc. As such, the meter data controller 202 can determine, based on the source identifiers of the monitored media resources, whether reference media resources are available for a threshold percentage of the total exposure duration. In some examples, the meter data controller 202 may skip mapping the monitored media resource IDs to source identifiers.

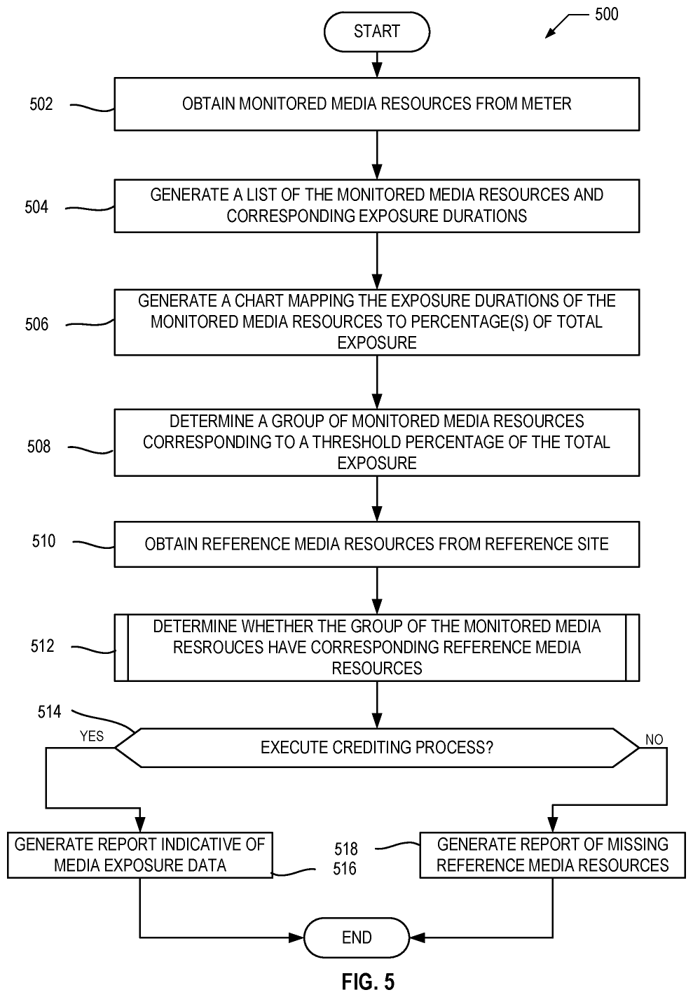

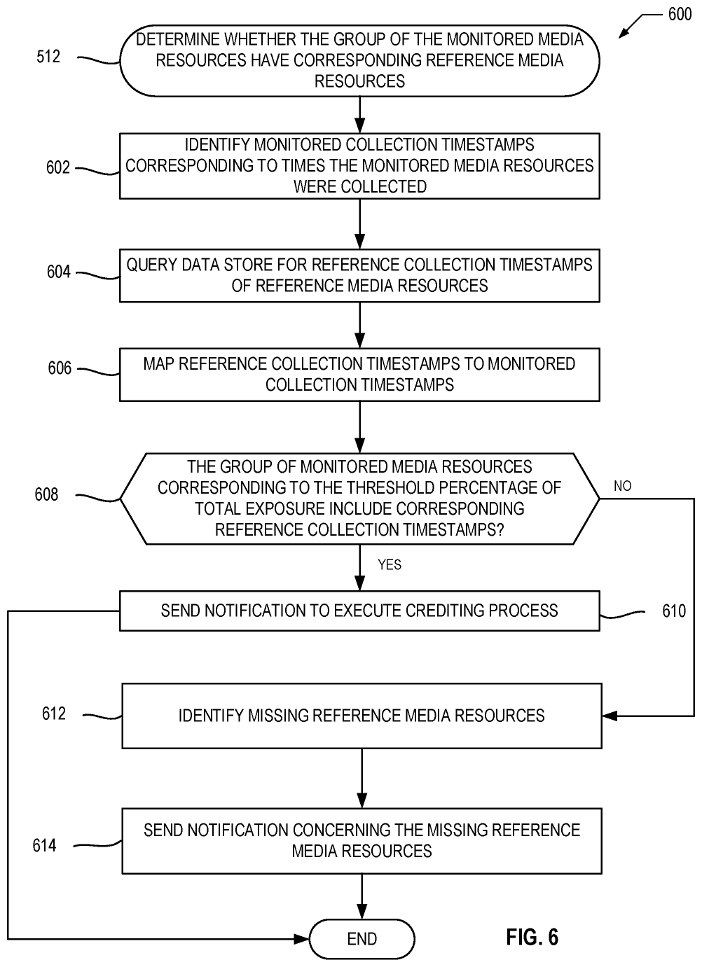

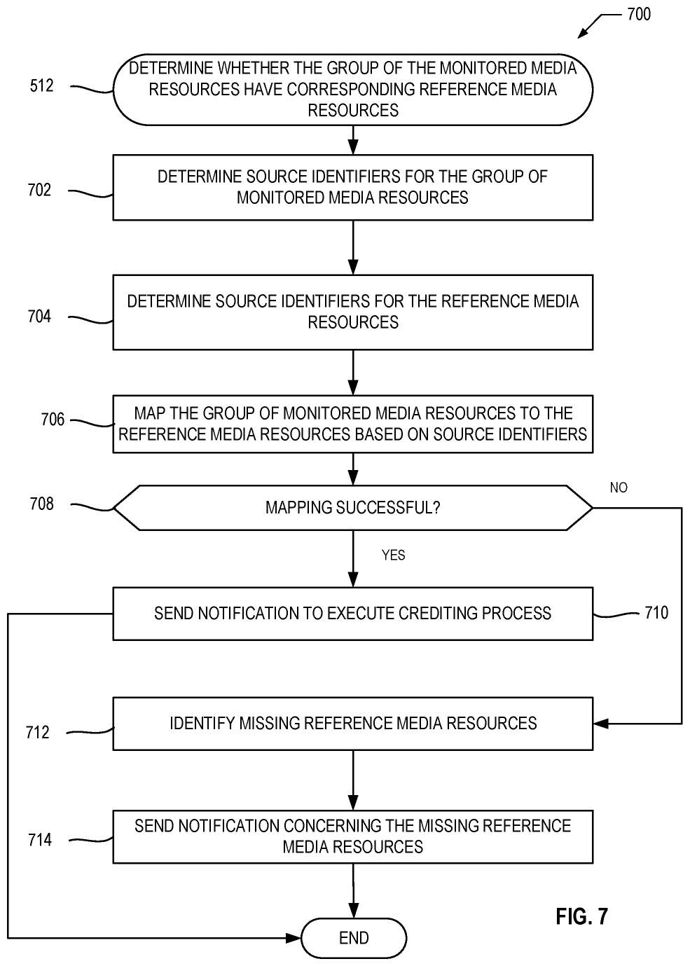

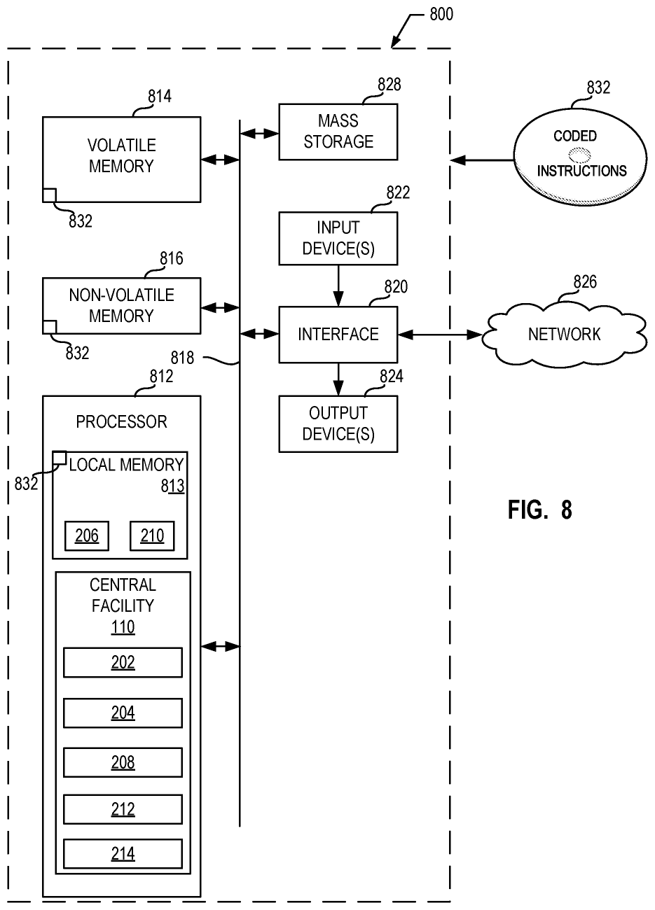

In some examples, the meter data controller 202 implements means for determining, means for identifying media, means for mapping, means for controlling meter data, and/or meter data controlling means. The meter data controlling means is implemented by executable instructions such as that implemented by at least blocks 502, 504, 505, 508, and 512 of FIG. 5, blocks 602, 604, 606, 608, 610, 612, and 614 of FIG. 6, and/or at least blocks 702, 704, 706, 708, 710, 712, and 714 of FIG. 7. The executable instructions of blocks 502, 504, 506, 508, and 512 of FIG. 5, blocks 602, 604, 606, 608, 610, 612, and 614 of FIG. 6, and/or at least blocks 702, 704, 706, 708, 710, 712, and 714 of FIG. 7 may be executed on at least one processor such as the example processor 812 of FIG. 8. In some examples, the meter data controlling means is implemented by hardware logic, hardware implemented state machines, logic circuitry, and/or any other combination of hardware, software, and/or firmware.

In FIG. 2, the example reference data controller 204 is implemented by a processor. The example reference data controller 204 obtains reference media resources (e.g., monitored media signatures and/or monitored watermarks) from the example reference site 108 via the network 106. In some examples, the reference data controller 204 obtains reference media resources in intervals of time and/or at specific times of a day. The example reference data controller 204 is coupled to the example data store 206 to store (e.g., cache) reference media resources as it is obtained from the example reference site 108. In some examples, the reference data controller 204 stores reference media resources with corresponding collection timestamps to use for subsequent processing. For example, an MMS may provide reference media resource identifiers (IDs) with a collection timestamp corresponding to the time of collection and/or generation. The collection timestamps of reference media resources can be used to determine whether to execute a crediting process.

In some examples, the reference data controller 204 implements means for obtaining reference data, means for controlling reference data, and/or reference data controlling means. The reference data controlling means is implemented by executable instructions such as that implemented by at least block 510 of FIG. 5. The executable instructions of blocks 510 of FIG. 5 may be executed on at least one processor such as the example processor 812 of FIG. 8. In some examples, the reference data controlling means is implemented by hardware logic, hardware implemented state machines, logic circuitry, and/or any other combination of hardware, software, and/or firmware.

In FIG. 2, the example data store 206 stores media resources (e.g., monitored media resources and/or reference media resources), identifying data (e.g., source identifiers, timestamps, collection timestamps, etc.), etc. The example data store 206 may be any device for storing data such as, for example, flash memory, magnetic media, optical media, etc. Furthermore, the data stored in the data store 206 may be in any data format such as, for example, binary data, comma delimited data, tab delimited data, structured query language (SQL) structures, etc. While in the illustrated example the data store 206 is depicted as a single database, the data store 206 may be implemented by multiple databases. In some examples, the data store 206 stores the list 300 of FIG. 3.

In FIG. 2, the example source identifier mapping controller 208 is implemented by a processor. The example source identifier mapping controller 208 maps and/or enables the mapping of monitored media resources to source identifiers. In some examples, the source ID mapping controller 208 obtains monitored media resources from the data store 206 and determines whether the monitored media resources include a corresponding source ID. In some examples, the source ID mapping controller 208 stores the source IDs in memory 210 which is accessible by the meter data controller 202 for use in mapping the monitored media resources to the source IDs. In some examples, the source ID mapping controller 208 maps reference media resources to source IDs. In some examples, the reference data controller 204 obtains reference media resources that have previously been mapped to the source IDs by the reference site 108. In some examples, the source ID mapping controller 208 can map monitored media resources to source IDs based on information stored in the data store 206. For example, the source ID mapping controller 208 can obtain the list of monitored media resources (e.g., the list 300), analyze the monitored media resources, and determine whether the monitored media resources are numerical values that correspond to a source ID. In some examples, the monitored media resources have numerical identifiers that are indicative of a source ID (e.g., a decoded watermark includes a source ID). In some examples, the monitored media resources do not have identifiers that are indicative of the source IDs (e.g., the decoded watermark have an identifier but the identifier is not representative of a source ID) and, thus, the source ID mapping controller 208 may utilize logic to determine whether source IDs correspond to monitored media resources.

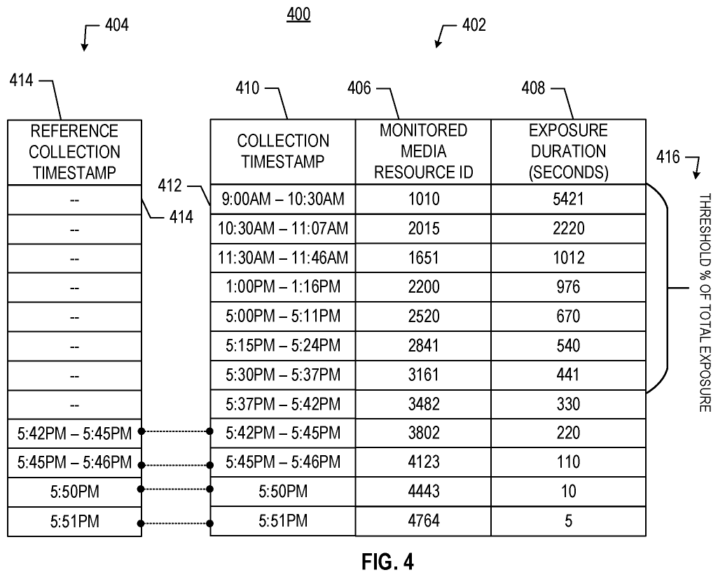

In some examples, the source ID mapping controller 208 is not utilized during post processing at the central facility 110. For example, the central facility 110 may desire to use a time-based approach to determine whether to credit monitored media resources. For example, the central facility 110 utilizes the collection timestamps associated with the monitored media resources to determine whether the data store 206 and/or the reference data controller 204 has obtained and/or collected reference media resources having matching collection timestamps as the monitored media resources. Such an example is described in further detail below in connection with FIG. 4.

Turning to FIG. 4, an example mapping 400 is illustrated. The example mapping 400 illustrates a mapping between reference collection timestamps of reference media resources and monitored collection timestamps of monitored media resources. The example mapping 400 includes an example first list 402 and an example second list 404. The example first list 402 illustrates a list of monitored media resources identifiers, exposure durations, and corresponding collection timestamps. The example second list 404 illustrates a list of reference collection timestamps.

In some examples, the meter data controller 202 of FIG. 2 generates the first list 402 and stores it at the data store 206 of FIG. 2. The example first list 402 includes a monitored media resource ID column 406 and an exposure duration column 408. The monitored media resource ID column 406 is the first column of data 302 of the example first list 300 of FIG. 3. For example, the monitored media resource ID column 406 includes monitored media resource ID 1010, which may be representative of channel A and monitored media resource ID 2015, which may be representative of channel B. The example exposure duration column 408 is the second column of data 304 of the example first list 300 of FIG. 3. For example, the exposure duration column 408 illustrates that monitored media resource ID 1010 includes an exposure duration of 5421 seconds and illustrates that monitored media resource ID 2015 includes an exposure duration of 2220 seconds.

In FIG. 4, the example mapping 400 illustrates an example collection timestamp column 410. The example collection timestamp column 410 includes times at which a monitored media resource ID was first collected and when the monitored media resource ID was last collected (e.g., a start exposure time and an end exposure time) by the meter data controller 202. In some examples, the collection timestamp column 410 may include more than just the start and end times of the monitored media resource IDs. For example, the collection timestamp column 410 can include a list of all the collection timestamps corresponding to when a monitored media resource ID was collected, which can occur at many times (e.g., periodically, aperiodically, etc.). For example, a first row 412 depicts monitored media resource ID 1010 having an exposure duration of 5421 seconds, a first collected timestamp of 9:00 AM, and a last collected timestamp of 10:30 AM. In some examples, the collection timestamp column 410 may depict, for the first row 412, a list of times, such as 9:01 AM, 9:02 AM, 9:03 AM, . . . 10:30 AM. In some examples, the list of times may be aperiodic and, thus, the first row 412 may depict a list of times, such as 9:06 AM, 9:11 AM, 9:25 AM, 9:32 AM, . . . 10:30 AM. In some examples, the collection timestamp column 410 can be utilized to determine and/or populate the exposure duration column 408. For example, the meter data controller 202 utilizes the first collected timestamp for a monitored media resource ID and a last collected timestamp for the monitored media resource ID to determine the duration of exposure for that monitored media resource ID.

In some examples, the reference data controller 204 of FIG. 2 generates the second list 404 and stores it at the data store 206 of FIG. 2. The example second list 404 includes a reference collection timestamp column 414. The example reference data controller 204 generates the data in the reference collection timestamp column 412 based on reference media resources obtained from the reference site 108. The example reference collection timestamp column 414 includes times at which a reference media resource was first detected and/or collected and when the reference media resource was last detected and/or collected (e.g., a start exposure time and an end exposure time) by the reference site 108. In some examples, the reference site 108 detects and/or collects reference media resources (e.g., reference watermarks) at the time media sources broadcast media and, in some examples, the reference site 108 generates reference media resources (e.g., reference signatures) at the time media sources broadcast media. For example, channel A broadcasts media at time 9:00 AM and, thus, the reference site 108 generates and/or detects a reference media resource, corresponding to channel A, at 9:00 AM. In some examples, the reference site 108 fails to generate and/or detect reference media resources at the times the media sources broadcast media. For example, the reference site 108 may be delayed due to clock issues, connection to the network 106 being down, etc. In such an example, the reference data controller 204 does not obtain reference media resources. For example, the reference collection timestamp column 414 includes a second row 414 that illustrates two dashed lines, “--”, indicating that no reference collection timestamps were collected. In some examples, the second row 414 corresponds to the first row 412, such that the second row 414 is a space in memory (e.g., the data store 206) reserved for data corresponding to the time 9:00 AM. Because the example reference data controller 204 did not obtain a reference media resource at the time 9:00 AM, the example data store 206 and/or the example reference collection timestamp column 414 does not have data populated in the second row 414. In some examples, the dashed lines are used for the purpose of description and, thus, the data store 206 and/or the reference data controller 204 do not reserve space in memory for data of particular times. In FIG. 4, the example reference collection timestamp column 414 includes a number of missing and/or null reference collection timestamps. In such an example, the reference data controller 204 did not obtain reference media resources having collection timestamps corresponding to the collection timestamps of monitored media resources.

In FIG. 4, the example meter data controller 202 maps a portion of the example reference collection timestamp column 414 to a portion of the example collection timestamp column 410. In some examples, the reference data controller 204 maps the portion of the example reference collection timestamp column 414 to the portion of the example collection timestamp column 410. For example, the meter data controller 202 may query the reference data controller 204 and/or data store 206 for reference collection timestamps matching the collection timestamps of the monitored media resource IDs. In some examples, the meter data controller 202 utilizes a mapping identifier to map matching collection timestamps between the monitored media resources and the reference media resources. In some examples, the meter data controller 202 generates a new list of data including reference collection timestamps, monitored media resources, exposure durations, and monitored collection timestamps. In some examples, the meter data controller 202 utilizes the mapping of reference collection timestamps to determine whether to initiate the crediting process of monitored media resources.

In some examples, such as the example of FIG. 4, the reference data controller 204 may not obtain enough reference media resources to use for matching the monitored media data. For example, the portion of the reference collection timestamp column 414 (e.g., reference collection timestamp 5:42 PM-5:45 PM, 5:45 PM-5:46 PM, 5:50 PM, and 5:51 PM) that is mapped to the portion of the collection timestamp column 410 (e.g., monitored timestamp 5:42 PM-5:45 PM, 5:45 PM-5:46 PM, 5:50 PM, and 5:51 PM) is not included in a group 416 of monitored media resource IDs corresponding to a threshold percent of total exposure. The group 416 is the group 310 of FIG. 3. For example, the meter data controller 202 calculates the threshold percent based on summing the exposure durations (e.g., the exposure durations in the exposure duration column 408) to determine the total exposure duration of the monitored media resources (e.g., the monitored media resource IDs in the monitored media resource ID column 406), then determining a percentage of that total exposure that corresponds to the threshold. In FIG. 4, none of the monitored media resource IDs that make up the threshold percent of total exposure (e.g., the group 416 of monitored media resource IDs) having matching reference collection timestamps. In such an example, the meter data controller 202 determines that the crediting process should not be initiated.

In some examples, not illustrated, the reference data controller 204 may populate the reference collection timestamp column 414 with reference collection timestamps that match the monitored collection timestamps of the collection timestamp column 410. For example, the reference data controller 204 obtains reference media resources having timestamps of 9:00 AM, 10:30 AM, 11:30 AM, 1:00 PM, etc., and stores the reference collection timestamps (and reference media resources) in the data store 204 for subsequent access by the meter data controller 202. The example meter data controller 202 may determine, after mapping, that the monitored media resource IDs making up the threshold percent of total exposure (e.g., the group 416 of monitored media resource IDs) have matching reference collection timestamps. In such an example, the meter data controller 202 determines that the crediting process is to be initiated.

In some examples, the source ID mapping controller 208 implements means for mapping and/or mapping means. The mapping means is implemented by executable instructions such as that implemented by at least blocks 702, 704, 706, 708, 710, 712, and 714 of FIG. 7. The executable instructions of blocks 702, 704, 706, 708, 710, 712, and 714 of FIG. 7 may be executed on at least one processor such as the example processor 812 of FIG. 8. In some examples, the mapping means is implemented by hardware logic, hardware implemented state machines, logic circuitry, and/or any other combination of hardware, software, and/or firmware.

Turning back to FIG. 2, the example central facility 110 includes the example crediting controller 212 to execute a crediting process to identify media sources and media data of the monitored media resources. The example crediting controller 212 is implemented by a processor. The example crediting controller 212 is initiated by the example meter data controller 202. For example, the crediting controller 212 is initiated based on a notification from the meter data controller 202 indicative to start crediting. In some examples, the crediting controller 212 is initiated by the example reference data controller 204. For example, the crediting controller 212 is initiated based on a notification from the reference data controller 204 indicative to start crediting. In some examples, the notification(s) is/are indicative that sufficient reference media resources have been obtained to perform crediting.

In some examples, the crediting controller 212 obtains monitored media resources for an evaluation period. For example, the crediting controller 212 is to match and/or map monitored media resources, corresponding to an evaluation period of 9:00 AM to 6:00 PM, with reference media resources. In such an example, the crediting controller 212 selects a monitored media resource ID (e.g., monitored media resource ID 1010) having a particular collection timestamp and exposure duration and searches the data store 206 for reference media resources that correspond to the selected monitored media resource ID and collection timestamp. The example crediting controller 212 may utilize any type of crediting technique to credit monitored media resources. In some examples, the crediting controller 212 credits monitored signatures by comparing and matching the monitored signatures with reference signatures. In some examples, the crediting controller 212 credits monitored watermarks when the monitored watermarks do not include enough information to identify an original distributor, a channel, etc. In such an example, the crediting controller 212 utilizes reference watermarks to supplement missing information from the monitored watermarks.

In some examples, the crediting controller 212 implements means for crediting and/or crediting means. The crediting means is implemented by executable instructions such as that implemented by at least block 514 of FIG. 5. The executable instructions of block 514 of FIG. 5 may be executed on at least one processor such as the example processor 812 of FIG. 8. In some examples, the crediting means is implemented by hardware logic, hardware implemented state machines, logic circuitry, and/or any other combination of hardware, software, and/or firmware.

In FIG. 2, the example central facility 110 includes the example report generation controller 214 to generate a report for clients of media measuring entities and/or for administrators of the central facility 110. In some examples, the report generation controller 214 generates reports indicative of media exposure data based on credited monitored media resources. In some examples, the report generation controller 214 generates reports indicative of missing reference media resources that were not obtained by the central facility 110. For example, the report generation controller 214 generates a report that identifies which monitored media resources did not have corresponding reference media resources based on the source IDs or the collection timestamps.

In some examples, the report generation controller 214 is initiated by the meter data controller 202 to generate a report of missing reference media resources. For example, if the meter data controller 202 determines that there is not a sufficient amount of reference media resources to execute the crediting process, the meter data controller 202 notifies the report generation controller 214. In some examples, the report generation controller 214 obtains the mapping 400 of FIG. 4 to generate the report of missing reference media resources. In some examples, the report generation controller 214 queries the data store 206 for information corresponding to source ID mapping between reference media resources and monitored media resources to generate the report of missing reference media resources.

In some examples, the report generation controller 214 is initiated by the crediting controller 212 to generate a report indicative of media exposure data. For example, the crediting controller 212 provides media exposure data to the report generation controller 214 based on hits made during the crediting process, such as hits when matching reference signatures of a reference database to monitored signatures. In some examples, the report generation controller 214 generates a report that includes demographic information associated with the media exposure data. Such demographic information is obtained by the meter data controller 202 during collection of monitored media resources from the media environment 102. The example report generation controller 214 may store the report at the example data store 206. In some examples, the report generation controller 214 sends the report to clients of media measurement entities and/or administrators of the central facility 110. In some examples, the reports indicative of missing reference media resources can be utilized by central facility administrators to troubleshoot why the reference media resources were not generated at the correct time, what caused the delay, and how to prevent such a delay in the future.

In some examples, the report generation controller 214 implements means for generating reports and/or report generating means. The report generating means is implemented by executable instructions such as that implemented by at least blocks 516 and 518 of FIG. 5. The executable instructions of blocks 516 and 518 of FIG. 5 may be executed on at least one processor such as the example processor 812 of FIG. 8. In some examples, the report generating means is implemented by hardware logic, hardware implemented state machines, logic circuitry, and/or any other combination of hardware, software, and/or firmware.

While an example manner of implementing the central facility 110 of FIG. 1 is illustrated in FIG. 2, one or more of the elements, processes and/or devices illustrated in FIG. 2 may be combined, divided, re-arranged, omitted, eliminated and/or implemented in any other way. Further, the example meter data controller 202, the example reference data controller 204, the example data store 206, the example source ID mapping controller 208, the example crediting controller 212, the example report generation controller 214, and/or, more generally, the example central facility 110 of FIG. 1 may be implemented by hardware, software, firmware and/or any combination of hardware, software and/or firmware. Thus, for example, any of the example meter data controller 202, the example reference data controller 204, the example data store 206, the example source ID mapping controller 208, the example crediting controller 212, the example report generation controller 214 and/or, more generally, the example central facility 110 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example meter data controller 202, the example reference data controller 204, the example data store 206, the example source ID mapping controller 208, the example crediting controller 212, and/or the example report generation controller 214 is/are hereby expressly defined to include a non-transitory computer readable storage device or storage disk such as a memory, a digital versatile disk (DVD), a compact disk (CD), a Blu-ray disk, etc. including the software and/or firmware. Further still, the example central facility 110 of FIG. 1 may include one or more elements, processes and/or devices in addition to, or instead of, those illustrated in FIG. 1, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

Flowcharts representative of example hardware logic, machine readable instructions, hardware implemented state machines, and/or any combination thereof for implementing the central facility 110 of FIG. 1 are shown in FIGS. 5-7. The machine readable instructions may be one or more executable programs or portion(s) of an executable program for execution by a computer processor and/or processor circuitry, such as the processor 812 shown in the example processor platform 800 discussed below in connection with FIG. 8. The programs may be embodied in software stored on a non-transitory computer readable storage medium such as a CD-ROM, a floppy disk, a hard drive, a DVD, a Blu-ray disk, or a memory associated with the processor 812, but the entire program and/or parts thereof could alternatively be executed by a device other than the processor 812 and/or embodied in firmware or dedicated hardware. Further, although the example programs are described with reference to the flowcharts illustrated in FIGS. 5-7, many other methods of implementing the example central facility 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 5-7 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 5 illustrates an example program 500 to determine whether to execute a crediting process. The example program 500 begins with the example central facility 110 (FIG. 1) obtaining monitored media resources from a meter (block 502). For example, the meter data controller 202 (FIG. 2) obtains monitored media resources from the media environment 102 (FIG. 1) via the network 106 (FIG. 1). In some examples, the meter data controller 202 obtains monitored media resources at periodic intervals, aperiodic intervals, once a day, etc.

The example central facility 110 generates a list of the monitored media resources and corresponding exposure durations (block 504). For example, the meter data controller 202 generates a list, a table, an array, and/or any data structure that includes a first column indicating monitored media resources (e.g., monitored watermarks, monitored signatures, etc.) and a second column including for how long the monitored media resources were collected. For example, the meter data controller 202 generates a list such as the list 300 of FIG. 3.

The example central facility 110 generates a chart mapping the exposure durations of the monitored media resources to percentages of total exposure (block 506). For example, the meter data controller 202 generates a Pareto chart with the list of monitored media resources and exposure durations based on any type of graphing algorithm, statistical algorithm, etc. In some examples, the meter data controller 202 generates a graph, a diagram, and/or any other type of statistical model to represent and/or depict the monitored media resources and exposure durations.

The example central facility 110 determines a group of monitored media resources corresponding to a threshold percentage of the total exposure (block 508). For example, the meter data controller 202 utilizes the chart to determine a group of monitored watermarks and/or monitored signatures that make up a threshold percentage of the total exposure. In some examples, the threshold percentage of total exposure is 95%. For example, the monitored media resources that are indicative of media exposed and/or consumed for 95% of the total exposure of all media that was obtained by the central facility 110 at block 502 are included in the group of monitored media resources that corresponds to the threshold percentage of total exposure. In some examples, the threshold percentage may be any percentage of total exposure. In some examples, the threshold percentage is managed and/or determined by the central facility 110.

The example central facility 110 obtains reference media resources from the reference site 108 (FIG. 1) (block 510). For example, the reference data controller 204 (FIG. 2) obtains reference watermarks and/or reference signatures from the reference site 108 via the network 106. In some examples, the reference data controller 204 obtains reference watermarks and/or reference signatures from the reference site 108 at periodic intervals, aperiodic intervals, once a day, etc. In some examples, the reference data controller 204 is to obtain the reference media resources corresponding to a live stream of reference media assets. For example, if a media source is broadcasting live media (e.g., not on-demand) to the media environment and a meter of the media environment is collecting and/or generating monitored media resources as the media source is broadcasting live media, the monitored media resources can be considered “live” media resources. In some examples, the reference data controller 204 may obtain reference media data corresponding to on-demand media assets (e.g., media not included as a part of a broadcast schedule, such as Netflix® shows, Amazon Prime® shows, etc.).

The example central facility 110 determines whether the group of monitored media resources have corresponding reference media resources (block 512). For example, the meter data controller 202 determines whether the central facility 110 has obtained reference media resources associated with the group of monitored media resources corresponding to the threshold percentage of total exposure such that the crediting process can be executed. Example programs corresponding to determining whether the group of monitored media resources have a sufficient amount of reference media resources are described in further detail below in connection with FIGS. 6 and 7.

The example central facility 110 determines whether to execute the crediting process (block 514). For example, the crediting controller 212 (FIG. 2) determines whether to match monitored signatures with reference signatures based on whether the group of monitored signatures have a sufficient amount of reference signatures. In some examples, the crediting controller 212 determines whether to map monitored watermarks with information of reference watermarks based on whether the group of monitored watermarks do not have enough media identifying information and based on whether there is a sufficient amount of reference watermarks. In some examples, the crediting controller 212 determines to execute the crediting process based on a notification from the meter data controller 202 and/or the reference data controller 204.

In some examples, if the crediting controller 212 obtains a notification indicative to execute the crediting process (e.g., block 514 returns a value YES), the example central facility 110 generates a report indicative of media exposure data (block 516). For example, the report generation controller 214 (FIG. 2) obtains results from the crediting controller 212 and generates a report having such results. In some examples, the results from the crediting controller 212 include media exposure data such as impressions, media reach, demographic information corresponding to the impressions, etc.

In some examples, if the crediting controller 212 obtains a notification indicative to not execute the crediting process (e.g., block 514 returns a value NO), the example central facility 110 generates a report indicative of missing reference media resources (block 518). For example, the report generation controller 214 obtains a notification from the meter data controller 202 including information corresponding to reference media resources that were not provided for a threshold percent of monitored media resources.

The example program 500 ends when the central facility 110 generates a report. In some examples, the program 500 repeats when the central facility 110 obtains monitored media resources from the media environment 102.

FIG. 6 includes a first example program 600 to determine whether the group of monitored media resources have corresponding reference media resources available at the central facility 110. The example program 600 may be executed to implement block 512 of FIG. 5. The program 600 begins with the central facility 110 identifying monitored collection timestamps corresponding to times the monitored media resources were collected (block 602). For example, the meter data controller 202 obtains timestamps from monitored watermarks and/or monitored signatures to determine what time the meter of the media environment 102 collected the monitored watermarks and/or monitored signatures. For example, referring to FIG. 4, the example first list 402 illustrates that monitored media resource ID 1010 was collected at 9:00 AM to 10:30 AM. In some examples, the monitored media resource ID 1010 may include any number of collection timestamps indicating the different times the meter collected them.

The example central facility 110 queries the data store 206 (FIG. 2) for reference collection timestamps of reference media resources (block 604). For example, meter data controller 202 accesses the reference media resources from the data store 206 to obtain collection timestamps for mapping to the monitored collection timestamps.

The example central facility 110 maps the reference collection timestamps to monitored collection timestamps (block 606). For example, the meter data controller 202 assigns a mapping identifier to a monitored media resource ID that has a corresponding reference collection timestamp. For example, referring to the mapping 400 of FIG. 4, the meter data controller 202 determines that monitored media resource ID 3802 has a collection timestamp that matches a collection timestamp stored at the data store 206 (e.g., 5:42 PM-5:45 PM). In such an example, the meter data controller 202 connects the two collection timestamps (e.g., the reference collection timestamp of 5:42 PM-5:45 PM and the monitored collection timestamp corresponding to monitored media resource ID 3802), as depicted with the dashed line. In some examples, the meter data controller 202 connects the two collection timestamps (e.g., the reference collection timestamp of 5:42 PM-5:45 PM and the monitored collection timestamp corresponding to monitored media resource ID 3802) by assigning a mapping identifier to the monitored media resource ID 3802.

The example central facility 110 determines if the group of monitored media resources corresponding to the threshold percentage of total exposure includes corresponding reference collection timestamps (block 608). For example, the meter data controller 202 determines if a mapping identifier has been assigned to all the monitored media resource IDs that are included in the group. For example, referring to the mapping 400 of FIG. 4, the meter data controller 202 analyzes monitored media resource ID 1010, monitored media resource ID 2015, monitored media resource ID 1651, monitored media resource ID 2200, monitored media resource ID 2520, monitored media resource ID 2841, and monitored media resource ID 3161 for a mapping identifier that maps those IDs to reference collection timestamps.

If the example central facility 110 determines that the group of monitored media resources corresponding to the threshold percentage of total exposure includes corresponding reference collection timestamps (e.g., block 608 returns a value YES), the example central facility 110 sends a notification to execute the crediting process (block 610). For example, the meter data controller 202 generates a notification indicative of sufficient amounts of reference media resources stored in the data store 206 to send to the crediting controller 212.

If the example central facility 110 determines that the available reference media resources do not include reference collection timestamps associated with the group of monitored media resources corresponding to the threshold percentage of total exposure (e.g., block 608 returns a value NO), the example central facility 110 identifies the reference media resources that have not been obtained (block 612). For example, the meter data controller 202 identifies which ones of the monitored media resources do not have mapping identifiers and, thus, can determine the type of reference media resource that was not received and/or obtained by the reference data controller 204. For example, referring to the mapping 400 of FIG. 4, the example meter data controller 202 determines that none of monitored media resource ID 1010, monitored media resource ID 2015, monitored media resource ID 1651, monitored media resource ID 2200, monitored media resource ID 2520, monitored media resource ID 2841, and/or monitored media resource ID 3161 are mapped to reference collection timestamps. Therefore, the values of the monitored media resource IDs are the values of the reference media resources that were not loaded and/or generated by the reference site 108.

The example central facility 110 sends a notification that identifies the missing reference media resources that have not been obtained (block 614). For example, the meter data controller 202 generates a notification for the crediting controller 212 and the report generation controller 214 to not execute the crediting process and to generate a report including the ones of the missing reference media resources.

The program 600 ends when the central facility 110 generates and sends notifications. The example program 600 may be repeated when the central facility 110 obtains new monitored media resources that have not been checked for corresponding reference media resources.

FIG. 7 illustrates a second example program 700 to determine whether the group of monitored media resources have corresponding reference media resources available at the central facility 110. The example program 700 may be executed to implement block 512 of FIG. 5. The example program 700 may be executed in parallel with the example program 600. In some examples, the program 700 may be execute based on instructions from the central facility 110 to use source identifiers to determine whether to execute the crediting process. The program 700 begins with the central facility 110 determining source identifiers for the group of monitored media resources (block 702). For example, the source ID mapping controller 208 (FIG. 2) may query the data store 206 and/or the meter data controller 202 for monitored media resources to analyze. In some examples, the source ID mapping controller 208 analyzes the monitored media resources to determine whether the monitored media resources are mapped to or include values representative of source IDs stored in memory 210 (FIG. 2). In some examples, the meter data controller 202 may query the data store 206 and/or the source ID mapping controller 208 for source IDs to analyze. In some examples, the meter data controller 202 analyzes the monitored media resources to determine whether the monitored media resources are mapped to or include values representative of source IDs stored in memory 210. In some examples, a monitored watermark may include a source ID encoded in the payload of the monitored watermark. In some examples, a monitored signature is linked to a source ID when the source is known for the monitored signature (e.g., based on a reference signature, if available).

The example central facility 110 determines source identifiers for the reference media resources (block 704). For example, the source ID mapping controller 208 may query the data store 206 and/or the reference data controller 204 for reference media resources to analyze. In some examples, the source ID mapping controller 208 analyzes the reference media resources to determine whether the reference media resources are mapped to or include values representative of source IDs stored in memory 210. In some examples, the meter data controller 202 may query the data store 206 and/or the reference data controller 204 for reference media resources to analyze. In some examples, the meter data controller 202 analyzes the reference media resources to determine whether the reference media resources are mapped to or include values representative of a source ID stored in memory 210. In some examples, a reference watermark is decoded to determine the source ID included in the payload of the reference watermark. In some examples, a reference signature is linked to a source, such as a channel, from which the reference signature was generated.

The example central facility 110 maps the group of monitored media resources to the reference media resources based on the source IDs (block 706). For example, the source ID mapping controller 208 includes a number of source IDs for the group of monitored media resources and a number of source IDs for the reference media resources and compares the two numbers to determine which ones of the group of monitored media resources and the reference media resources have matching source IDs. In some examples, the meter data controller 202 includes a list of source IDs for the group of monitored media resources and a list of source IDs for the reference media resources and compares the two lists to determine which ones of the group of monitored media resources and the reference media resources have matching source IDs.

The example central facility 110 determines whether the mapping was successful (block 708). For example, the source ID mapping controller 208 determines whether any hits were made during the comparison between the two lists of source IDs for the group of monitored media resources and the reference media resources. In some examples, the source ID mapping controller 208 determines mapping was successful based on how many hits were counted (e.g., how many monitored media resources had the same source ID as the reference media resources). In some examples, the meter data controller 202 determines whether any hits were made during the comparison between the two lists of source IDs for the group of monitored media resources and the reference media resources. In some examples, the meter data controller 202 determines mapping was successful based on how many hits were counted (e.g., how many monitored media resources had the same source ID as the reference media resources).

If the example central facility 110 determines that mapping was successful (e.g., block 708 returns a value YES), the example central facility 110 sends a notification to execute the crediting process (block 710). For example, the source ID mapping controller 208 generates a notification indicative of sufficient amounts of reference media resources stored in the data store 206 to send to the crediting controller 212. In some examples, the meter data controller 202 generates a notification indicative of sufficient amounts of reference media resources stored in the data store 206 to send to the crediting controller 212.

If the example central facility 110 determines that mapping was not successful (e.g., block 708 returns a value NO), the example central facility 110 identifies missing reference media resources (block 712). For example, the source ID mapping controller 208 determines which monitored media resources did not have source IDs with successful matches to source IDs of reference media resources. The example source ID mapping controller 208 identifies the list of missing reference media resources. In some examples, the meter data controller 202 determines which monitored media resources did not have source IDs with successful matches to source IDs of reference media resources. The example meter data controller 202 generates the list of missing reference media resources.

The example central facility 110 sends a notification concerning the missing reference media resources (block 714). For example, the source ID mapping controller 208 generates a notification for the crediting controller 212 and the report generation controller 214 to not execute the crediting process and to generate a report including the ones of the missing reference media resources. In some examples, the meter data controller 202 generates a notification for the crediting controller 212 and the report generation controller 214 to not execute the crediting process and to generate a report including the ones of the missing reference media resources.

The program 700 ends when the central facility 110 generates and sends notifications. The example program 700 may be repeated when the central facility 110 obtains new monitored media resources that have not been checked for corresponding reference media resources.

FIG. 8 is a block diagram of an example processor platform 800 structured to execute the instructions of FIGS. 5-7 to implement the central facility 110 of FIG. 1. The processor platform 800 can be, for example, a server, a personal computer, a workstation, a self-learning machine (e.g., a neural network), an Internet appliance, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example meter data controller 202, the example reference data controller 204, the example source ID mapping controller 208, the example crediting controller 212, and the example report generation controller 214.

The processor 812 of the illustrated example includes a local memory 813 (e.g., a cache). In some examples, the local memory 813 implements the example data store 206 and the example memory 210. The processor 812 of the illustrated example is in communication with a main memory including a volatile memory 814 and a non-volatile memory 816 via a bus 818. The volatile memory 814 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a universal serial bus (USB), a Bluetooth® interface, a near field communication (NFC) interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 824 are also connected to the interface circuit 820 of the illustrated example. The output devices 824 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives.

The machine executable instructions 832 of FIGS. 5-7 may be stored in the mass storage device 828, in the volatile memory 814, in the non-volatile memory 816, and/or on a removable non-transitory computer readable storage medium such as a CD or DVD.

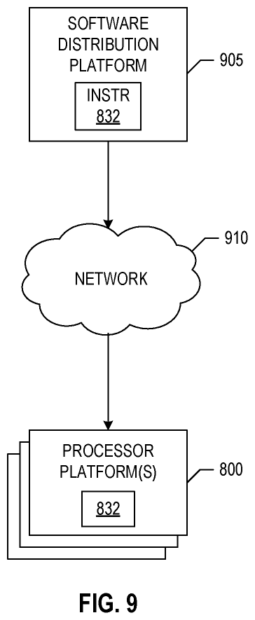

A block diagram illustrating an example software distribution platform 905 to distribute software such as the example machine readable instructions 832 of FIG. 8 to hardware devices owned and/or operated by third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 832 of FIG. 8. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 832, which may correspond to the example machine readable instructions 500, 600, 700 of FIGS. 5-7, as described above. The one or more servers of the example software distribution platform 905 are in communication with a network 910, which may correspond to any one or more of the Internet and/or any of the example networks 106 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 832 from the software distribution platform 905. For example, the software, which may correspond to the example machine readable instructions 500 of FIG. 5, example machine readable instructions 600 of FIG. 6, and/or example machine readable instructions 700 of FIG. 7, may be downloaded to the example processor platform 800, which is to execute the machine readable instructions 832 to implement the central facility 110. In some example, one or more servers of the software distribution platform 905 periodically offer, transmit, and/or force updates to the software (e.g., the example machine readable instructions 832 of FIG. 8) to ensure improvements, patches, updates, etc., are distributed and applied to the software at the end user devices.

From the foregoing, it will be appreciated that example methods, apparatus and articles of manufacture have been disclosed that increase the accuracy of matching monitored media data to identify media data for media exposure records. The disclosed methods, apparatus and articles of manufacture improve the efficiency of using a computing device by reducing the processing time and processing resource spent for unnecessary matching of non-existent reference media data to monitored media data. The disclosed methods, apparatus and articles of manufacture are accordingly directed to one or more improvement(s) in the functioning of a computer.

Example methods, apparatus, systems, and articles of manufacture to reduce false crediting from delayed reference sites are disclosed herein. Further examples and combinations thereof include the following:

Example 1 includes an apparatus comprising at least one memory, computer readable instructions, and at least one processor to execute instructions to at least generate a list of first media resources mapped to respective durations of time, the first media resources having corresponding monitored timestamps, the first media resources to represent monitored media exposure, generate a mapping of the respective durations of time to respective percentages of total media exposure, wherein the total media exposure corresponds to a sum of the respective durations of time, determine, based on the mapping, a group of the first media resources that correspond to a threshold percentage of the total media exposure, and determine whether to execute a media crediting process based on whether the group of the first media resources have first timestamps corresponding second timestamps of second media resources stored in memory, the second media resources to represent reference media sources.

Example 2 includes the apparatus of example 1, wherein the at least one processor is to query the memory to determine whether the first timestamps having matching second timestamps.

Example 3 includes the apparatus of example 1, wherein the first media resources are obtained from a meter, and the respective durations of time correspond to respective durations of media exposure monitored by the meter.

Example 4 includes the apparatus of example 1, wherein a first portion of the first media resources is mapped to a first duration of time and corresponds to a first media source, a second portion of the first media resources is mapped to a second duration of time and corresponds to a second media source, and the total media exposure corresponds to a sum of at least the first duration of time and the second duration of time.

Example 5 includes the apparatus of example 1, wherein the at least one processor is to execute the media crediting process to credit the monitored media exposure to ones of the reference media sources responsive to determining that the group of the first media resources have first timestamps corresponding the second timestamps of the second media resources.

Example 6 includes the apparatus of example 1, wherein the at least one processor is to not execute the media crediting process responsive to determining that the group of the first media resources does not have first timestamps corresponding to the second timestamps of second media resources.

Example 7 includes the apparatus of example 6, wherein the at least one processor is to determine missing portions of the second media resources that have not been stored in the memory for crediting the first media resources based on the first timestamps of the first media resources not having matching second timestamps in the second media resources, and generate a report that identifies the missing portions of the second media resources.

Example 8 includes At least one non-transitory computer readable storage medium comprising instructions that, when executed, cause one or more processors to at least generate a list of first media resources mapped to respective durations of time, the first media resources having corresponding monitored timestamps, the first media resources to represent monitored media exposure, generate a mapping of the respective durations of time to respective percentages of total media exposure, wherein the total media exposure corresponds to a sum of the respective durations of time, determine, based on the mapping, a group of the first media resources that correspond to a threshold percentage of the total media exposure, and determine whether to execute a media crediting process based on whether the group of the first media resources have first timestamps corresponding second timestamps of second media resources stored in memory, the second media resources to represent reference media sources.

Example 9 includes the at least one non-transitory computer readable storage medium of example 8, wherein the instructions cause the one or more processors to query the memory to determine whether the first timestamps having matching second timestamps.

Example 10 includes the at least one non-transitory computer readable storage medium of example 8, wherein the first media resources are obtained from a meter, and the respective durations of time correspond to respective durations of media exposure monitored by the meter.

Example 11 includes the at least one non-transitory computer readable storage medium of example 8, wherein the instructions cause the one or more processors to map a first portion of the first media resources to a first duration of time and a second portion of the first media resources to a second duration of time, the first portion corresponds to a first media source, the second portion corresponds to a second media source, and the total media exposure corresponds to a sum of at least the first duration of time and the second duration of time.

Example 12 includes the at least one non-transitory computer readable storage medium of example 8, wherein the instructions cause the one or more processors to execute the media crediting process to credit the monitored media exposure to ones of the reference media sources responsive to determining that the group of the first media resources have first timestamps corresponding the second timestamps of the second media resources.

Example 13 includes the at least one non-transitory computer readable storage medium of example 8, wherein the instructions cause the one or more processors to not execute the media crediting process responsive to determining that the group of the first media resources does not have first timestamps corresponding to the second timestamps of second media resources.

Example 14 includes the non-transitory computer readable storage medium of example 13, wherein the instructions cause the one or more processors to determine missing portions of the second media resources that have not been stored in memory for crediting the first media resources based on the first timestamps of the first media resources not having matching second timestamps in the second media resources, and generate a report that identifies the missing portions of the second media resources.

Example 15 includes a method comprising generating a list of first media resources mapped to respective durations of time, the first media resources having corresponding monitored timestamps, the first media resources to represent monitored media exposure, generating, by executing an instruction with at least one processor, a mapping of the respective durations of time to respective percentages of total media exposure, wherein the total media exposure corresponds to a sum of the respective durations of time, determining, based on the mapping, a group of the first media resources that correspond to a threshold percentage of the total media exposure, and determining, by executing an instruction with the at least one processor, whether to execute a media crediting process based on whether the group of the first media resources have first timestamps corresponding second timestamps of second media resources stored in memory, the second media resources to represent reference media sources.

Example 16 includes the method of example 15, further including querying the memory to determine whether the first timestamps having matching second timestamps.

Example 17 includes the method of example 15, further including mapping a first portion of the first media resources to a first duration of time and a second portion of the first media resources to a second duration of time, the first portion corresponding to a first media source, the second portion corresponding to a second media source, and the total media exposure corresponds to a sum of at least the first duration of time and the second duration of time.

Example 18 includes the method of example 15, further including executing the media crediting process to credit the monitored media exposure to ones of the reference media sources responsive to determining that the group of the first media resources have first timestamps corresponding the second timestamps of the second media resources.

Example 19 includes the method of example 15, further including not executing the media crediting process responsive to determining that the group of the first media resources does not have first timestamps corresponding to the second timestamps of second media resources.

Example 20 includes the method of example 19, further including determining missing portions of the second media resources that have not been stored in memory for crediting the first media resources based on the first timestamps of the first media resources not having matching second timestamps in the second media resources, and generating a report that identifies the missing portions of the second media resources.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
at least one memory;
computer readable instructions; and
at least one processor to execute instructions to at least:
generate a list of first media resources mapped to respective durations of time, the first media resources having corresponding monitored timestamps, the first media resources to represent monitored media exposure;
generate a mapping of the respective durations of time to respective percentages of total media exposure, wherein the total media exposure corresponds to a sum of the respective durations of time;
determine, based on the mapping, a group of the first media resources that correspond to a threshold percentage of the total media exposure;
compare first timestamps of the group of the first media resources to second timestamps of second media resources from a reference site to identify whether the reference site delayed transmission of one or more of the second media resources, the second media resources to represent reference media sources; and
determine whether to execute a media crediting process based on the comparison.

2. The apparatus of claim 1, wherein the second media resources are stored in the at least one memory, and the at least one processor is to query the at least one memory to determine whether the first timestamps having matching second timestamps.

3. The apparatus of claim 1, wherein the first media resources are obtained from a meter, and the respective durations of time correspond to respective durations of media exposure monitored by the meter.

4. The apparatus of claim 1, wherein a first portion of the first media resources is mapped to a first duration of time and corresponds to a first media source, a second portion of the first media resources is mapped to a second duration of time and corresponds to a second media source, and the total media exposure corresponds to a sum of at least the first duration of time and the second duration of time.

5. The apparatus of claim 1, wherein the at least one processor is to execute the media crediting process to credit the monitored media exposure to ones of the reference media sources responsive to determining that the group of the first media resources have first timestamps corresponding the second timestamps of the second media resources.

6. The apparatus of claim 1, wherein the at least one processor is to not execute the media crediting process responsive to determining that the group of the first media resources does not have first timestamps corresponding to the second timestamps of second media resources.

7. The apparatus of claim 6, wherein the second media resources are stored in the at least one memory, and the at least one processor is to:
determine missing portions of the second media resources that have not been stored in the at least one memory for crediting the first media resources based on the first timestamps of the first media resources not having matching second timestamps in the second media resources; and
generate a report that identifies the missing portions of the second media resources.

8. At least one non-transitory computer readable storage medium comprising instructions that, when executed, cause one or more processors to at least:
generate a list of first media resources mapped to respective durations of time, the first media resources having corresponding monitored timestamps, the first media resources to represent monitored media exposure;
generate a mapping of the respective durations of time to respective percentages of total media exposure, wherein the total media exposure corresponds to a sum of the respective durations of time;
determine, based on the mapping, a group of the first media resources that correspond to a threshold percentage of the total media exposure;
compare first timestamps of the group of the first media resources to second timestamps of second media resources from a reference site to identify whether the reference site delayed transmission of one or more of the second media resources, the second media resources to represent reference media sources; and
determine whether to execute a media crediting process based on the comparison.

9. The at least one non-transitory computer readable storage medium of claim 8, wherein the second media resources are stored in memory, and the instructions cause the one or more processors to query the memory to determine whether the first timestamps having matching second timestamps.

10. The at least one non-transitory computer readable storage medium of claim 8, wherein the first media resources are obtained from a meter, and the respective durations of time correspond to respective durations of media exposure monitored by the meter.

11. The at least one non-transitory computer readable storage medium of claim 8, wherein the instructions cause the one or more processors to map a first portion of the first media resources to a first duration of time and a second portion of the first media resources to a second duration of time, the first portion corresponds to a first media source, the second portion corresponds to a second media source, and the total media exposure corresponds to a sum of at least the first duration of time and the second duration of time.

12. The at least one non-transitory computer readable storage medium of claim 8, wherein the instructions cause the one or more processors to execute the media crediting process to credit the monitored media exposure to ones of the reference media sources responsive to determining that the group of the first media resources have first timestamps corresponding the second timestamps of the second media resources.

13. The at least one non-transitory computer readable storage medium of claim 8, wherein the instructions cause the one or more processors to not execute the media crediting process responsive to determining that the group of the first media resources does not have first timestamps corresponding to the second timestamps of second media resources.

14. The non-transitory computer readable storage medium of claim 13, wherein the second media resources are stored in memory, and the instructions cause the one or more processors to:
determine missing portions of the second media resources that have not been stored in the memory for crediting the first media resources based on the first timestamps of the first media resources not having matching second timestamps in the second media resources; and
generate a report that identifies the missing portions of the second media resources.

15. A method comprising:
generating a list of first media resources mapped to respective durations of time, the first media resources having corresponding monitored timestamps, the first media resources to represent monitored media exposure;
generating, by executing an instruction with at least one processor, a mapping of the respective durations of time to respective percentages of total media exposure, wherein the total media exposure corresponds to a sum of the respective durations of time;
determining, based on the mapping, a group of the first media resources that correspond to a threshold percentage of the total media exposure;
comparing, by executing an instruction with the at least one processor, first timestamps of the group of the first media resources to second timestamps of second media resources stored in memory from a reference site to identify whether the reference site delayed transmission of one or more of the second media resources, the second media resources to represent reference media sources; and
determining, by executing an instruction with the at least one processor, whether to execute a media crediting process based on the comparison.

16. The method of claim 15, wherein the second media resources are stored in memory, and further including querying the memory to determine whether the first timestamps having matching second timestamps.

17. The method of claim 15, further including mapping a first portion of the first media resources to a first duration of time and a second portion of the first media resources to a second duration of time, the first portion corresponding to a first media source, the second portion corresponding to a second media source, and the total media exposure corresponds to a sum of at least the first duration of time and the second duration of time.

18. The method of claim 15, further including executing the media crediting process to credit the monitored media exposure to ones of the reference media sources responsive to determining that the group of the first media resources have first timestamps corresponding the second timestamps of the second media resources.

19. The method of claim 15, further including not executing the media crediting process responsive to determining that the group of the first media resources does not have first timestamps corresponding to the second timestamps of second media resources.

20. The method of claim 19, wherein the second media resources are stored in memory, and further including:
determining missing portions of the second media resources that have not been stored in the memory for crediting the first media resources based on the first timestamps of the first media resources not having matching second timestamps in the second media resources; and generating a report that identifies the missing portions of the second media resources.
